(19) United States
(12) Patent Application Publication
(10) Pub. No.: US 2026/0329842 A1
(43) Pub. Date: Oct. 22, 2026

(54) EXTENSIBLE, AUDITABLE, FLEXIBLE ENTITY RELATIONSHIP MODEL FOR CENTRALIZED DATABASE

(71) Applicant: Oracle International Corporation, Redwood Shores, CA (US)

(72) Inventors: Mohammad Ahmed Memon, Seattle, WA (US); Amit Alon, Belmont, CA (US); Jeffrey Trent, Altamonte Springs, FL (US)

(73) Assignee: Oracle International Corporation, Redwood Shores, CA (US)

(21) Appl. No.: 19/363,214

(22) Filed: Oct. 20, 2025

Related U.S. Application Data
(60) Provisional application No. 63/792,757, filed on Apr. 22, 2025.

(51) Int. Cl. G06F 16/23; G06F 40/205; G06F 40/284; G06F 40/295; G06N 3/04; G06N 7/02

(52) U.S. Cl. CPC G06F 16/2358; G06F 40/205; G06F 40/284; G06F 40/295; G06N 3/04; G06N 7/02

(57) ABSTRACT

The present disclosure relates to techniques for managing a centralized resource database that integrates data from multiple sources within a multi-entity system, enabling seamless data access, modification, and customization while preserving historical auditability. The disclosed techniques may involve an append-only centralized database maintained by a server endpoint, allowing entities including organizations, contributors, or other servers to update, and access data records inside the centralized database via APIs. The centralized database may support hybrid storage (using immutable attributes and JSON rows) and updates tailored for different entities without requiring frequent schema modifications. An integrated configuration entity may be used to track every update with time stamps and unique version identifiers, enabling version control and historical consistency. The disclosed techniques may further contribute to extensibility by enabling dynamic schema handling and custom attributes, auditability through version-tracked modifications and metadata logs, and flexibility by supporting various data formats while enabling seamless entity interactions.

### CROSS REFERENCE TO RELATED APPLICATIONS

This application claims the benefit of U.S. Provisional Patent Application No. 63/792,757 filed on Apr. 22, 2025. The entire disclosure of the aforementioned application is incorporated by reference herein in its entirety for all purposes.

### BACKGROUND

Efficient management of payer and health plan information is a concern for service providers (such as hospitals, car dealerships companies, or business companies) for accurate billing, claims processing, and subject care. However, the lack of a standardized system for payer identification and routing may lead to inefficiencies, manual verification efforts, and increased administrative costs. According to 2023 CAQH index report, variations in payer names across clearinghouses, absence of a national payer identifier, and reliance on outdated processes contribute to delays and errors, costing payers and providers millions of dollars annually.

Traditional data management systems may struggle to handle the complexities of multi-entity environments, where multiple entities such as service providers, payers, and clearinghouses continuously generate and modify records. These challenges of managing multi-entity data may become particularly evident when intermediaries such as clearinghouses, experience data compromises, which may result in widespread data loss and inconsistencies. In such situations, operational disruptions may occur due to the corruption or unavailability of records that may lead to extensive manual reconciliation across fragmented databases, which in turn may result in financial and operational strain. Moreover, the absence of a robust versioning system may make it difficult for organizations to determine the most up-to-date and accurate records, further delaying restoration efforts. Additionally, as clearinghouses often operate independently with different payer databases, discrepancies may arise when a subject switches providers. This switching may require manual verification of prior claims and payer details, creating inefficiencies that may lead to delays in claims processing and authorization potential financial losses, and subject dissatisfaction.

Fragmented data governance across multiple entities may further contribute to misalignment in payer-provider interactions, forcing organizations to rely on outdated reconciliation processes. Without a unified system, organizations may face risks of inconsistent data updates, leading to discrepancies in payer and provider records. Furthermore, the lack of a centralized approach may increase the administrative burden, undermining the data integrity when multiple stakeholders are involved in record modifications. As multiple entities update records, conflicts and discrepancies may arise, necessitating a more structured approach to data governance. Therefore, innovative techniques for enhancing seamless data integration, maintaining historical record continuity while supporting flexible updates to the data may be effective.

### SUMMARY

Some embodiments of the present disclosure relate to techniques for managing a centralized database that enables modifications or overrides from one or more entities in a centralized system while maintaining auditability and version control. The centralized database may store records or data associated with multiple subjects. The centralized system may enable various entities such as organizations (client organizations or an entity interacting with or accessing the record), contributors (an entity contributing or participating in modifying and accessing data in the centralized database), and intermediary entities (entity that may facilitate transactions, data validation, and reconciliation between the organizations and contributors), to access and update the records via application programming interfaces (APIs), based on a plurality of predefined entity-specific access rules. The records may include both core attributes (e.g., static immutable data shared across all records) and extended attributes (e.g., dynamic data that may be modified or updated by the entities) enabling multi-source data ingestion and flexibility across stakeholders (or entities). This data ingestion may assist different entities to have unified, consistent data or records that may be accessed simultaneously as well as updated by the entities, enabling easy integration over time. Thus, the disclosed techniques may contribute to extensibility by enabling entity-specific access rules, and flexibility by accommodating different formats for care and extended attributes while enabling seamless and centralized entity interactions.

Additionally, the disclosed techniques may support auditability by enabling modifications, updates and/or overrides that may be tracked through metadata logs or configuration logs (also referred herein as configuration entities). The configuration entity may be used for defining a the relationship between the contributor (e.g., a resource provider) and the organization. For example, when an organization is related to a resource provider, custom or context-specific information (e.g. different contact details, emails, or operational rules) may be stored or updates separately by both entities. Thus, the configuration entity may allow for these updates and overrides to be tracked and applied without modifying the base structure or model of the centralized database. The configuration entity may exist for each record stored in the centralized database, and stores the metadata associated with the record, and details of overrides and updates applied overtime to the record. Moreover, The configuration entity is a separate table (or logical construct) that acts as a context-aware override mechanism. It may be used to establish relationships between entities by storing reference IDs (e.g., organization ID, resource provider ID, etc.) and contains extended attributes to represent any overrides, updates, or contextual modifications relevant to that relationship.

In the centralized database, data or record associated with each core business entity (such as the organization, or the resource provider) may be stored in a separate relational table having a predefined schema, where each record instance may uniquely be identified by a UUID. These are the primary entities of the system, and they may contain core attributes as well as extended attributes specific to that entity. The extended attributes may comprise publicly accessible fields available to external systems, APIs, or authorized users of the entities, that may be updated or modified based on entity-specific access rules. These extended attributes may exist in the form of JSON rows. In contrast, the core attributes may include static immutable data that remains consistent and unmodified across all the records once initialized. This immutable data may include, for example, a universally unique identifier (UUID) for each record, a logical ID for internal version tracking, a subject ID assigned to a subject (an entity, individual, asset, or process that is the focal point of interactions, transactions, or modifications within the system, e.g., a patient, a shipment, a customer, a student, a citizen record, or an employee), an organization ID (representing the service provider (e.g. a hospital, a bank, an educational institute, an educational institution, or digital marketplace), a contributor ID (or a resource provider ID, indicating an insurance company, vendor, supplier, or financial institutions associated with the subject), and a timestamp indicating when the record was first created. Additionally, the extended attributes may comprise append-only fields that authorized users of the entities may modify via UIs or APIs. For example, a clearinghouse updating an assigned hospital for a subject, a hospital adding treatment details to a patient's record, or a car dealership company updating a car's financing or warranty details.

Furthermore, the extended attributes may include dynamic data that evolves over time based on system interactions. This data may encompass historical records detailing prior engagements, transaction history, transfer details, including contact information when an entity transitions between service providers, and recent activity summaries capturing past interactions and acquisitions. For example, if the subject represents an individual, and the organization is a service provider, the subject data may include stored records such as assessment reports, transactional details, and status updates on submitted requests. Since the extended attributes may vary based on operational needs, they may be stored in a flexible format such as JSON rows, allowing for flexibility for future changes, extensibility and adaptability across diverse industries and workflows.

The centralized system may follow an append-only model, in which for making an update to a record associated with a subject, previous data may be labeled as expired and replaced by updated information, enabling the centralized system to retain and store previous versions of the data, thus providing the version control that in turn may provide data integrity and auditability. This may be done by using a configuration log (also referred herein as a configuration entity).

The centralized database may be managed by a server operated by, for example, a data aggregator, a cloud service provider offering a platform for managing the centralized database, or any other entity responsible for handling transactional requests between organizations and contributors. Since multiple entities may be updating and accessing records simultaneously, the centralized system enables them to retrieve accurate, real-time information based on access policies and permissions. For example, if a logistics provider requests shipment details via an API, the system may return only the most current (non-expired) data. Alternatively, if a supplier updates inventory management rules, the previous record may be marked as “Expired,” and a new version may be generated.

According to some aspects of the present disclosure, an entity-representing another server, the organization, or the contributor)-may submit a request via an API to modify a base record of a subject. The base records may correspond to a current record of the subject stored in the centralized database that are managed by the server. The system may parse the request into information associated with the entity requesting an update. The system may further determine whether the entity complies with the entity-specific rules to validate if the requesting entity has permissions to modify or update the base record. The entity-specific access rules may include access control lists defining one or more entities having permissions to access certain records, entity roles for each entity of the one or more entities, the record that may be accessed or modified, and contextual conditions such as time of request, previous requests, or organizational relationships.

On determination that the requesting entity has permissions, the system may prompt the centralized database to make the requested update to the base record. This may be done by labeling the base record as, “Expired” and creating a new version of the base record with a version number to indicate sequential iteration and incorporating the updates to it. The updated record may have the core attributes of the base record, and only the extended attributes may be modified according to the request. For example, a version number of a base record may be set to one (i.e., version 1), and after an update or override, the first server may create version 2 while keeping the same logical ID. The version number may increment each time a record is updated.

The logical ID of both the base record and the updated record remains the same for internal tracking, however, a new universally unique identifier (UUID) may be assigned to each version of the record. Additionally, the system may log header data associated with the updated record in the configuration entity. The header data may include identifiers of both the base record and the updated record including the UUID, the logical ID, a timestamp of modification, the entity requesting the change, and details of the modified fields.

Additionally, may also store the details related to the override or update within the configuration entity associated with the record. For example, if an insurance provider updated their insurance rules, these may be stored in the extended attributes within the configuration entity. The extended attributes may then, for example, include details referring to the identifier of an authorized user of the insurance provider that updated the rule (e.g., override_payerID), rule name, an effective date, etc., Thus, if in case the insurance provider is related to a hospital (the identifier of which would already be stored in the configuration entity), the system may allow these overrides or updates to be reflected to the linked hospital.

Subsequently, if the entity submits a subsequent request to access a record from the centralized database, the system may parse the request to extract the associated identifiers from the configuration entity using wherein one or more semantic parsing techniques. The semantic parsing techniques my include regular expression-based tokenization or named entity recognition (NER) model. When parsing subsequent request, the system may determine whether the request is a PUT request (e.g., for modifying the record) or a GET request (e.g., for retrieving the record). Moreover, the system may extract the header data (e.g., UUID and the logical ID) associated with the record being accessed from the request payload. Once the header data is extracted, the system may determine if an entry corresponding to the extracted header data exists in the configuration entity. If such an entry does not exist, the system may prompt the centralized database to retrieve the requested record and send it to the requesting entity. Alternatively, if a corresponding entry exists in the configuration entity, the system may identify all the available versions of the record and then, based on predefined entity-specific access rules and entity preferences, may extract the required version (either the base record or the updated record) and return it to the requesting entity via the API.

In some embodiments, a system is provided that includes one or more data processors and a non-transitory computer readable storage medium containing instruction which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 illustrates an exemplary block diagram of a centralized database management system in a cloud network in accordance with some aspects of the present disclosure.

FIG. 2 illustrates an overview diagram of a centralized database, integrating core attributes and extended attributes in accordance with some aspects of the present disclosure.

FIG. 3 illustrates a sequence diagram for processing requests at first server received from a first entity and a second entity via an API gateway.

FIG. 4 shows an example flowchart for performing an override operation to a record in the centralized database to create an updated version.

FIG. 5 shows an example illustration of a configuration entity evolving as a result of the override operation in accordance with some aspects of the present disclosure.

FIG. 6A illustrates an exemplary user interface (UI) showing a dashboard of the centralized database management system at an organization endpoint.

FIG. 6B illustrates an exemplary user interface of a payer showing version history of a record.

FIG. 6C shows an exemplary UI of the first server showing version history of a record according to some aspects of the present disclosure.

FIG. 7 shows an example flowchart of a system for updating and storing versioning history of records in the centralized database according to some aspects of the present disclosure.

FIG. 8 depicts a simplified diagram of a distributed system for implementing an embodiment of the present disclosure.

FIG. 9 is a simplified block diagram of a cloud system environment in accordance with certain aspects of various embodiments of the invention.

FIG. 10 illustrates an exemplary computer system that may be used to implement certain aspects of the present disclosure.

### DETAILED DESCRIPTION

Some embodiments of the present disclosure relate to techniques for managing a centralized database that integrates data from multiple entities within a multi-entity system. The techniques for the centralized database may offer seamless data access, modification, and customization while preserving historical auditability. The centralized database maintained by a server endpoint may support append-only database, enabling entities such as organizations, contributors, or other servers to update, and access data records via application programming interfaces (APIs). The centralized database may support custom attributes (using JSON-based storage), and updates tailored for different entities without requiring frequent schema modifications.

The centralized database may implement a standardized resource directory to facilitate the storage, modification, and retrieval of resource-related information within a centralized system (could-based). The centralized system may support users from multiple entities that may include an organization, a contributor, or a server to update and access data form the append-only centralized database to enable streamlined integration and accessibility.

In some aspects of the present disclosure, the contributor (also referred herein as a service provider) may be an entity that interacts with the organization, such as an insurance provider, supplier, vendor, financial service provider, or regulatory body. Contributor information may include, but is not limited to, the contributor's name, geographic location, and encrypted identifiers associated with resources utilized across multiple entities. The services provided by contributors may encompass claim processing, preauthorization management, and the administration of networks comprising approved service providers.

A server in the present disclosure refers to an entity, such as clearinghouses, payment processors, logistics hubs, or centralized registries, which acts as an intermediary for managing transactions, data exchanges, or regulatory compliance between organizations and contributors. The clearinghouses may be responsible for validating claims, standardizing data formats, and forwarding them to the appropriate contributor for further processing and payment. By automating these tasks, the clearinghouse may help reduce administrative burdens, minimize claim rejections, and expedite reimbursements. For example, a clearinghouse may receive a claim from a hospital, verify its compliance with contributor-specific requirements, and submit it to the corresponding insurance company for reimbursement. In addition to claims processing, clearinghouses may offer services such as eligibility verification, claims tracking, denial management, electronic remittance advice, and cost management for server exchanges or transaction fees. Prominent examples of healthcare clearinghouses include Office Ally® and Change Healthcare®. These capabilities collectively enhance operational efficiency and improve financial workflows for both service providers and contributors.

Furthermore, in the present disclosure, an organization refers to any entity that provides services and interacts with contributors or intermediaries for transactional processes. Examples of such organizations include healthcare providers (e.g., hospitals, clinics, and medical laboratories), automotive businesses (e.g., car dealerships and repair shops), educational institutions, financial institutions, logistics companies, business enterprises, or car dealership companies. The terms “service provider” and “organization” are used interchangeably to represent entities that engage with contributors, clearinghouses, or similar financial intermediaries.

According to some aspects of the present disclosure, a centralized database serves as a unified repository that stores policies, contributor identifiers, and resource-related information in a standardized format. The centralized database may be designed to support multiple entities or users, including organizations, contributors, and servers, enabling seamless access, updates, and modifications to stored records. Each resource within the database is associated with a specific API, allowing for structured interactions across different systems. Moreover, the entities interacting with the centralized database may include contributors, organizations, and server endpoints. These entities contribute to and retrieve data from the centralized system, ensuring streamlined access and modification of stored records. The centralized database may be a database that handles automated financial transaction processing at the cloud network.

The users accessing the centralized database may include authenticated personnel from various domains, such as enterprise employees, engineers, data analysts, legal professionals, researchers, administrators, auditors, compliance officers, or other authorized individuals interacting with the system. Additionally, users may include authenticated representatives of service providers, contributors, or intermediary entities responsible for submitting, modifying, or reviewing records related to transactions, policy updates, resource management, regulatory compliance, data reconciliation, or override handling. Depending on the use case, the users may represent professionals in industries such as healthcare, finance, logistics, education, telecommunications, or supply chain management.

Furthermore, the centralized database may either be managed by a server (a clearinghouse), or an enterprise that oversees data governance, access control, and record versioning. In some aspect, an enterprise—such as a cloud service provider—may host the centralized system, facilitating secure and scalable interactions between organizations, servers, and contributors. The enterprise may support multi-tenancy within a private cloud infrastructure, ensuring that distinct entities may securely access, modify, and retrieve data while maintaining compliance with entity-specific access rules. An example of such an enterprise could be a cloud-based infrastructure provider, such as Oracle™, that extends its services to other enterprises, allowing them to integrate with the centralized database for resource optimization, automated record management, and enhanced interoperability across multiple stakeholders. The centralized architecture may enhance data consistency, reduce redundancy, and streamline cross-entity transactions, thereby improving operational efficiency in resource management.

In some aspects, techniques may be provided for managing diverse, multi-entity data within a centralized database, enabling efficient updates and access across various stakeholders such as insurance companies, clearinghouses, and hospitals. The system offers extensible entity storage, integrating both standardized fields and dynamic JSON-based attributes. This allows the system to support a wide range of data types, from structured insurance policy details to dynamic hospital medical records, ensuring smooth interoperability across different entities.

Additionally, the centralized system may facilitate multi-source data integration, allowing seamless integration with a variety of data sources, such as databases, APIs, spreadsheets, and external registries. This enables the centralized database to continuously receive updates from different systems, e.g., be it a hospital's internal subject management system, electronic health record (EHR), or a contributor's claims processing system, thus maintaining a comprehensive view of the data.

Furthermore, the centralized database may be equipped to efficiently handle both sparse and dense data, ensuring adaptability in managing varying data complexities. Sparse data, such as newly added insurance policies with minimal information, may be effectively stored and integrated alongside dense data, such as comprehensive hospital records comprising subject details, medical histories, and treatment plans. For instance, machine-learning (ML) models may learn from past records to automatically format and standardize incoming data (e.g., normalizing contributor names across different sources). Similarly, clustering algorithms may be used to detect duplicate contributor entries or hospital records and suggest merging strategies and if a newly added insurance policy lacks some attributes, the ML models may infer missing values based on similar policies in the system.

According to some aspects, the centralized database may incorporate a configuration entity (or logical construct) that may act as a context-aware override mechanism. It may be used to establish relationships between entities by storing reference IDs (e.g., organization_ID, resource_id, etc.) and contains extended attributes to represent any overrides, updates, or contextual modifications relevant to that relationship. Rather than modifying the core schema of each record or entity table, updates or custom configurations (like a health plan update by an insurance provider) may be stored in the configuration entity. This may allow for defining or tracking overrides in scenarios such as contributor-specific policies within a clearinghouse or enabling entity interactions to be accurately recorded. The inclusion of the configuration entity may support data governance, traceability, and compliance monitoring, particularly in environments where multiple stakeholders interact with the database. To support versioning and auditablitiy, changes across any record may be tracked by creating new records with unique UUIDs, while maintaining a same logical ID (which functions as a stable identifier for that record across versions). By storing the logical IDs or version numbers for the related entities, the configuration entity may allow the system to link specific versions of records within a relationship, support rollback, history, and differential analysis, and enable traceability without requiring separate audit tables. For example, when a subject's medical record is updated or modified by a hospital or any other authorized entity, the system captures all changes in the configuration entity within the centralized database. Details such as the updated fields, the user responsible, time stamps, and contextual details (e.g., treatment updates or diagnosis revisions) may be stored in JSON rows inside the configuration entity. This may enable the system to maintain a transparent and comprehensive version history for compliance, auditing, and informed decision-making.

Upon receiving a request for the record from another entity (e.g., a clearinghouse, an insurance company), the system queries the configuration entity and presents all previous record versions along with modification details. This allows the requesting entity to view who made the changes, when they occurred, and why. ML techniques may further enhance version management by detecting anomalies, flagging unusual modifications, and suggesting the most relevant version based on historical usage. Natural Language Processing (NLP) models may also summarize changes and categorize them with relevant tags (e.g., “billing update,” “diagnostic correction”) for better usability on contributor and provider interfaces.

The concept of a centralized system managing a single database extends beyond the insurance industry, offering significant advantages in various fields. In financial services and banking, institutions handle vast amounts of data, including loan applications, transactions, and credit reports. Traditionally, this data is spread across multiple systems, making compliance and auditing complex. With a centralized system, financial records may be unified while maintaining a historical audit trail. For example, instead of overwriting changes to a customer's credit assessment, the system may track modifications over time, ensuring compliance with regulations such as Know Your Customer (KYC) and Anti-Money Laundering (AML).

A similar need arises in supply chain and logistics, where businesses manage inventory, shipping logs, and supplier contracts across disconnected platforms. A centralized database enables seamless tracking of product availability and pricing changes while preserving a complete audit history. For instance, rather than simply updating stock levels, the system logs every transaction, allowing businesses to analyze demand patterns and ensure transparency in supply chain operations.

Other industries, such as IoT and smart devices and government compliance auditing, also benefit from an immutable, append-only database. IoT systems may track firmware updates, sensor logs, and device settings without losing historical configurations. Meanwhile, government agencies may maintain tax filings, legal amendments, and citizen records with a clear audit trail, ensuring accountability and regulatory compliance. By integrating multi-source data management and version-controlled storage, this system provides a scalable solution applicable across multiple industries.

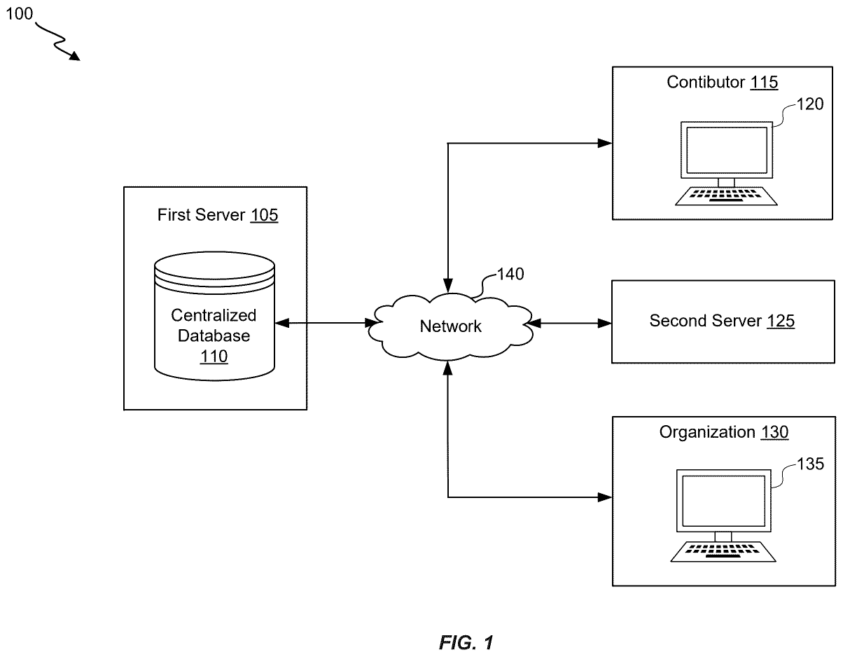

FIG. 1 illustrates an exemplary block diagram of a centralized system 100 at a cloud network in accordance with some aspects of the present disclosure. The centralized system 100 may include a first server 105, a network 140, a contributor 115, a second server 125, and an organization 130. At the core of the centralized system 100 is the first server 105, which may be operated by an enterprise or a clearinghouse, responsible for managing the centralized database 110. Moreover, the centralized database 110 may reside either on the cloud or be maintained on-premises within the first server 105. The centralized database 110 houses a variety of records, including subject treatment histories, insurance policy details, and health plan information, all of which may be updated as needed by authorized entities. The authorized entities, such as the contributor 115 (e.g., an insurance company) and the organization 130 (e.g., a hospital or healthcare provider), may interact with the first server 105 to modify, override, or update records through contributor interface 120 and organization interface 135. These interactions may occur through APIs, as the centralized database 110 may be deployed on a cloud network or maintained on-premises within the first server 105.

Additionally, the second server 125, representing another clearinghouse or intermediary entity, may also access the centralized database 110. A second clearinghouse may engage with the system to validate transactions, reconcile claims, or facilitate data exchange between different organizations. For example, a second clearinghouse may be responsible for ensuring that the subject data matches across different systems or that the claims processing is consistent with the health plan details provided by the contributor.

By enabling multiple entities to access and interact with a single, centralized source of truth, the system fosters data consistency, transparency, and traceability. The second server 125, as another clearinghouse, may play an essential role in enabling various parties within the healthcare and insurance networks to efficiently exchange and update data. This design may facilitate interoperability between different systems, helping to streamline operations, improve data accuracy, and enhance overall workflow efficiency across the entire network of service providers, insurance companies, and intermediaries.

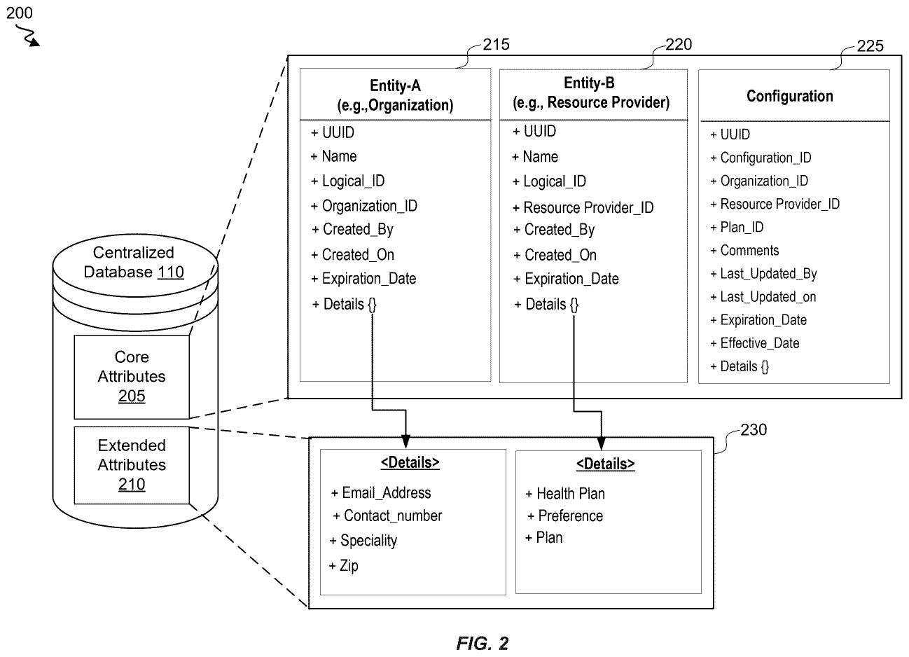

FIG. 2 illustrates an overview diagram 200 of the centralized database 110, integrating core attributes and extended attributes in accordance with some aspects of the present disclosure. The underlying architecture of the centralized database 110 may comprise two distinct layers: core attributes 205 and extended attributes 210. This hybrid approach may blend a relational model for core, fixed-schema attributes with a JSON-based model for dynamic, entity-specific attributes and allows for a stable foundation while accommodating evolving data requirements without frequent schema modifications.

The core attributes 205 may define a set of essential attributes shared across all entities, ensuring data consistency and historical traceability. Each entity in the database includes key relational fields entity-A 215 and entity-B 220. The relational fields or attributes may include UUID (universally unique identifier), “Logical_ID” (internal identifier for tracking), “Created_On” (timestamp of creation), “Last_Updated_On”, “Created_By”, “Last_Updated_By”, “Expiration_Date” (NULL for active otherwise DATE for expired), “Effective_Date”, and “Status”. Dates may be stored in UTC format to maintain consistency across systems, and an “Expiration_Date” field may be used to track whether a record is currently active or has been deprecated. The core attribute layer may enable backward compatibility and provides a reliable audit history for tracking data modifications.

Furthermore, the extended attributes 210 may allow for flexible data storage, enabling different entities such as contributors 115 and organizations 130 to store, modify, and override specific fields without affecting the core attributes 205. The override specific fields may include JSON objects or document-based storage inside the relational schema defined as details field 230 (all details, attributes that are public-facing may be part of this field), “fdex_Details” (internal fields for Oracle-specific use cases), “tmp_Details” (temporary fields for data that is being deprecated or needs relocation), and a version numbers field (stored in V_details). Each JSON entry may be assigned a version number, enabling historical data to remain accessible and allowing future schema changes to not break compatibility with existing records.

To accommodate various data access and visibility requirements, the system may categorize data into three distinct types: public-facing data, internal system data, and temporary data for deprecating legacy systems. Public-facing data comprise of records that external users such as hospitals, clearinghouses, and insurance providers may access via APIs or web interfaces. This may include contributor information, claim submission rules, reimbursement fee schedules, and compliance requirements. In contrast, internal system data may be reserved for the first server 105 (Oracle's or enterprise platform) for storing system configuration settings, configuration entity, and internal mappings that support operational workflows. Finally, temporary data storage provides a transitional space for phasing out legacy databases, allowing for a smooth migration process without disrupting active system operations.

The relational component of the database enables all resources, organizations, and server endpoints to share a structured foundation with essential attributes stored in fixed tables. The key identifiers (such as “UUID”, “Logical ID”, “Created On”, and “Expiration Date”) may remain consistent across all entities records to maintain integrity. On the other hand, the NoSQL component may introduce a flexible mechanism for storing entity-specific attributes within JSON rows. For instance, the contributor 115 (insurance company) may include a JSON entry for details field 230 as {“coverage types”: [“dental”, “vision”, “hospitalization”], “health plans”, “email address” }, while the organization 130 (Hospital) may have details field 230 as {“specialties”: [“cardiology”, “neurology”], “preferences”, “medical history”}. This approach enables schema flexibility, allowing new attributes to be introduced into the record without modifying the core database structure.

Additionally, the centralized database 110 incorporates a configuration entity 225 (or logical construct) that may act as a context-aware override mechanism. It may be used to establish relationships between entities by storing reference IDs (e.g., organization_ID, resource_id, etc.) and contains extended attributes to represent any overrides, updates, or contextual modifications relevant to that relationship. Rather than modifying the core schema of each record or entity table, updates or custom configurations (like a health plan update by an insurance provider) may be stored in the configuration entity 225. This may allow for defining or tracking overrides in scenarios such as contributor-specific policies within a clearinghouse or enabling entity interactions to be accurately recorded. The inclusion of the configuration entity 255 may support data governance, traceability, and compliance monitoring, particularly in environments where multiple stakeholders interact with the database. To support versioning and auditablitiy, changes across any record may be tracked by creating new records with unique UUIDs, while maintaining the same logical ID (which functions as a stable identifier for that record across versions). By storing the logical IDs or version numbers for the related entities, the configuration entity 255 may allow the system to link specific versions of records within a relationship, support rollback, history, and differential analysis, and enable traceability without requiring separate audit tables.

By integrating a hybrid relational-JSON approach, the architecture of the centralized database 110 may enhance data adaptability, supports interoperability, and maintain historical accuracy. Moreover, the core schema may provide a stable foundation, while the dynamic JSON attributes (e.g., the extended attributes 210) may enable customization and evolution based on industry needs. Whether used for contributor directories, claims processing, or service provider registries, this system enables diverse data types to coexist within a single, unified structure, fostering efficient data exchange and long-term scalability.

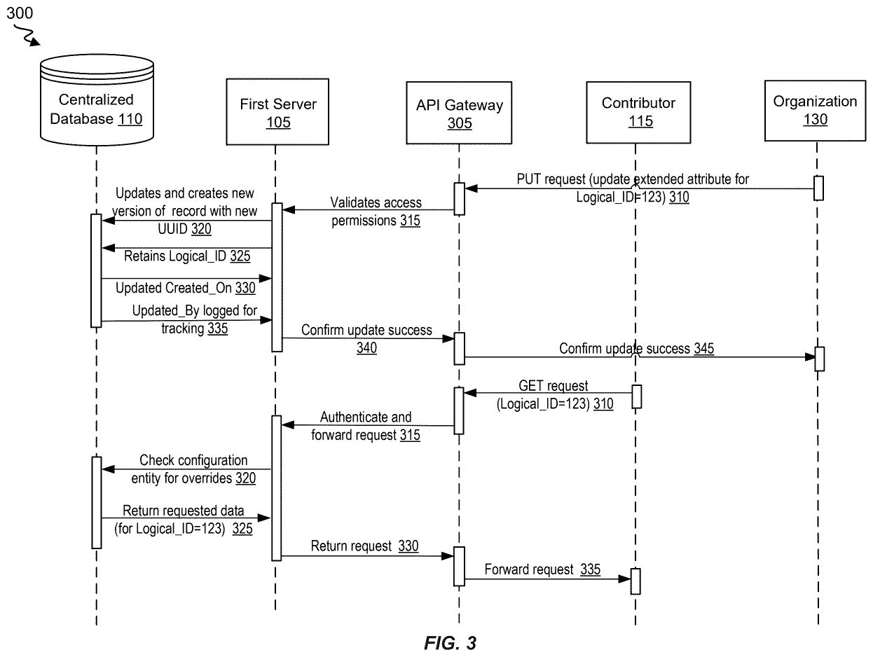

FIG. 3 illustrates a sequence diagram 300 for processing requests at first server 105 received from a first entity and a second entity via an API gateway. The requests may comprise of PUT and GET requests to specifically modify, update and access data records of individuals (e.g., subjects, contributors, service providers, etc.). The API gateway 305 serves as the intermediary for routing requests and enforcing security protocols. In the disclosed architecture, multiple entities including the contributor 115, organization 130, and second server 125 may send PUT and GET requests to modify, update, or retrieve data records associated with various stakeholders, such as subjects, contributors, and service providers. The first entity may correspond to at least one of the contributor 115, the organization 130, and the second server 125. For example, a contributor directory lookup API may be configured to retrieve details of insurance companies and their service plans for the organization (hospitals, car dealership companies or other businesses) to verify an insurance of the subject before submitting a request. A claim submission API may help the organization to submit an insurance request to a clearinghouse (first server), while enabling that the request is tracked throughout its progress. Similarly, a claim status API may retrieve a real-time status of an insurance request, enabling the organization to check whether the request has been approved and the amount reimbursed.

In the sequence diagram 300, a first entity i.e., the organization 130 may initiate a PUT request (update extended attribute for “Logical_ID”=123) 310 to update or override an attribute in a data record, which may be transmitted to the API gateway 305. The first entity may correspond to at least one of the contributor 115, the organization 130, and the second server 125.

The request may include updated data fields associated with a specific entity of the data record, identified by “Logical ID” 123. Upon receiving the request, the API gateway 305 may perform an access control check through the prompt 315 (validate access permissions). This validation process may include verifying authentication credentials, checking role-based access control (RBAC) policies, and authenticating if the requesting entity (in this case the organization 130) has the appropriate authorization to modify the specified data record. For instance, if a hospital (organization 130) submitting a PUT request to update a subject's insurance details in the centralized database 110, the hospital may need to update the insurance coverage status of a subject after a recent treatment or policy change. In this case, the request may include the operation type (for example “PUT/updateInsuranceDetails” to indicate that the hospital aims to update insurance details field of the record) along with a JSON object comprising identifiers of the record to be updated (i.e., “Logical ID”=123, which uniquely identifies the subject's record, and the fields to update (i.e., “Update Fields”: {“Coverage Status”: “Active”, “Effective Date”: “2025 Feb. 12”, “Contributor ID”: “XYZ123”}).

The API gateway 305 processes the request by validating whether the hospital has the necessary permissions to modify the subject's insurance details. Once the prompt 315 is completed, the request may proceed to the first server 105 responsible for processing updates to the centralized database 110. The first server 105 performs an update/override operation by sending a prompt 320 (update and create new version of record with new UUID) to the centralized database. Instead of modifying the existing record directly, the system may create a new version of the data record while preserving a base version. The existing “Logical ID” remains unchanged (i.e., “123”, same as the base version of the data record), while a new UUID may be assigned to the updated record. The updated record may include changes such as updated insurance plan details, policy effective dates, or new pre-authorization requirements for treatments.

Following the record update, the first server 105 sends a prompt 325 (confirmation message to retain Logical ID), indicating that the “Logical ID” remains intact for reference across related transactions (i.e., the contributor 115 and the organization 130). Subsequently, another prompt 330 (“Created On” updated) may involve updating the timestamp reflecting when the new version of the record was created. The timestamp allows tracking of record evolution over time and provides temporal context for data integrity checks.

As part of tracking modifications, the “Updated By” logged for tracking 335 prompt received at the first server 105 may indicate that the identity of the entity responsible for the update may be recorded and logged for future tracking. This step may include metadata such as the user ID, timestamp, and reason for the modification. Such tracking information allows the system to maintain accountability, facilitating compliance with regulatory auditing requirements.

Once these updates may be applied, the first server 105 sends a confirmation message 340 to the API gateway 305 to inform the organization 130 of a successful update to the data record. The API gateway 305 may log this response for monitoring and troubleshooting purposes before forwarding the final confirmation 345 back to the organization 130. Upon receiving this acknowledgment, the organization 130 may verify that the update has been processed successfully and that the new version of the record is now available for use.

Furthermore, a second entity, i.e., may submit a GET Request 310 to retrieve a specific subject's insurance record with the “Logical ID”=123 from the centralized database 110. The second entity may be at least one of the contributor 115 (insurance company), the organization 130 or the second server 125. In some aspects, the first entity and the second entity may be the same entity or different entities.

The request may be first received at the API gateway 305, which may perform authentication and authorization checks to verify whether the contributor 115 has the necessary permissions to access the requested data. If the request is valid, the API gateway 305 may proceed to authenticate and forward request at prompt 315 to the first server 105 for further processing. Upon receiving the request, the first server 105 queries the centralized database 110 and executes a prompt 320 (check the configuration entity for overrides) to apply any of the entity-specific access rules or data visibility constraints before retrieving the requested record. After this check, the system may determine how to return the data based on the entity-specific access rules and the contributor's data retrieval preferences.

In some aspects, the contributor may only be allowed to access the latest version of the record. For example, if a subject's insurance coverage was recently updated due to a policy renewal, modification in benefits, or a claim adjustment, the system retrieves only the most recent version of the record. As another example, if a subject's policy deductible was changed from $500 to $300, the first server 105 may retrieve the latest version reflecting the new deductible amount and sends it to the contributor 115 as part of the return requested data response 325. In some other aspects, depending on the contributor's access permissions, the system may return all past versions of the requested record. Such a scenario may be useful for auditing, compliance, or fraud detection purposes, where the insurance company may need to see how the record evolved over time. If a subject had three different insurance plans over the past five years, the system retrieves all historical versions of the policy records, with each version labeled with modification details such as who modified the record (e.g., hospital administrator, insurance representative), when the modification occurred (timestamp), and what changes were made (e.g., coverage amount, policy expiration date). The contributor 115 may analyze these records to track changes in coverage or identify potential discrepancies in claims processing.

Once the appropriate version(s) of the record is identified, the system may send the records to the first server 105 through a return prompt 325. The first server 105 sends the retrieved data records or just the required subset of data back to the API gateway 305, which may then forward the information to the contributor 115 as part of the prompt 330 (return requested data response). In some aspects, the contributor may not require the full insurance record but instead request only a specific field such as the subject's current policy status or coverage limits. If the contributor is only interested in whether a particular treatment is covered under the subject's policy, the system extracts just the “coverage status” field from the insurance record and returns only that specific data point, rather than sending the full policy details.

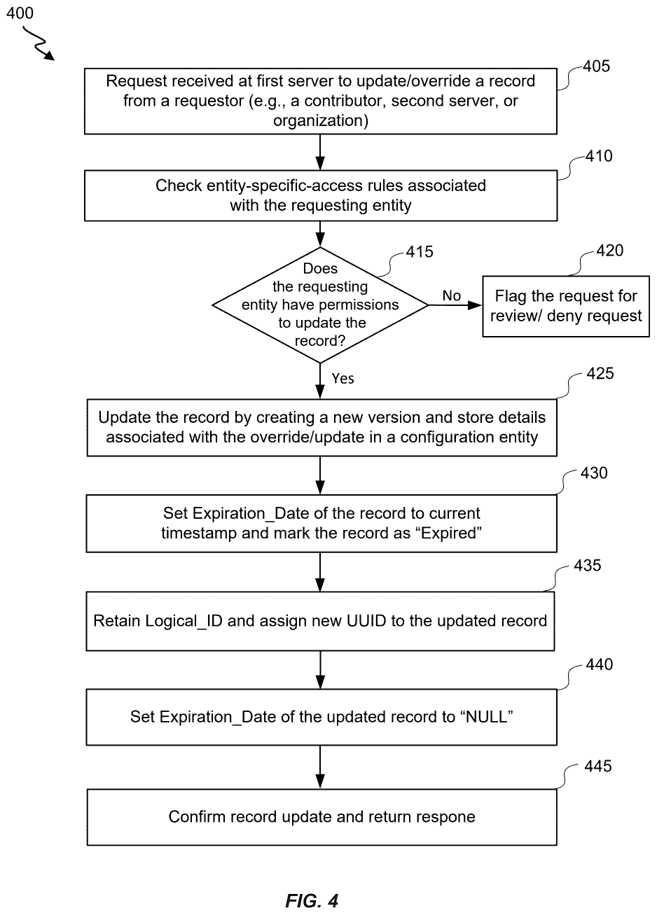

FIG. 4 shows an example flowchart 400 for performing an override operation to a record in the centralized database 110 to create an updated version. At block 405, a request may be received at the first server 105 to update/override a record associated with a subject from a requester. The requester may represent any entity including contributor 115, organization 130, the second server 125, or some other clearinghouse. Entity-specific access rules may correspond to a set of permissions that determine the level of access each requesting entity has to modify or view records in the system. These rules are designed such that only authorized entities, such as insurance companies, hospitals, clearinghouses, or other enterprises, may access or modify specific data fields within a record based on a role and a purpose. The first server 105 may validate these permissions at a decision block 415, and if the requesting entity has the appropriate permissions, the request may be approved for further processing. For example, an insurance company (contributor 115) may have permission to update data fields related to subject coverage details, such as policy limits, premium amounts, and deductible values. However, the insurance company may not be authorized to update sensitive information related to subject health data, such as diagnosis codes or treatment history. Similarly, a hospital (organization 130) may have permissions to modify subject treatment records, such as updating a subject's medical history, adding diagnosis codes, or recording administered treatments. However, hospitals may not have permissions to alter subject financial information such as insurance coverage, premium amounts, or deductible details, as these may be the responsibility of the insurance company.

For the second server 125 (another clearinghouse), which acts as an intermediary between the hospitals and insurance companies, the access rules may allow the clearinghouse to update or modify specific billing records or claims-related information but not subject health records. The clearinghouse may have access to specific transactional data like claim status, claim amounts, and payment history, but it may not be able to modify clinical details such as diagnosis codes or treatment procedures, which may only be controlled by the service provider and contributor entities.

To automate the validation of requests, machine-learning (ML) techniques such as access control models and supervised learning algorithms may be employed by the first server 105. A classification model, such as a decision tree or random forest, may be trained on historical data to predict whether a requesting entity should access specific records or fields. The model considers factors like user roles, access patterns, and previous authorized modifications to align requests with predefined access rules. Over time, reinforcement learning may further refine the model by learning from feedback and adjusting access decisions. For instance, if an insurance company frequently updates policy details, the model may automatically approve these requests, while flagging unusual requests for review by an administrator or simply denying request, at process 420. The model also incorporates configuration entity and user behavior to ensure compliance with regulations like HIPAA (Health Insurance Portability and Accountability Act), preventing unauthorized access to sensitive information.

Based on the approved request, at process 425, the first server 105 may update the record and store the details associated with the override or update in the configuration entity 225. All the modifications and changes made to the record fields, including the reason for the update and any relevant metadata, may be logged in the configuration entity 225, enabling a transparent audit trail. At process 430, the “Expiration_Date” of the original record may be set to the current timestamp, marking it as “Expired”, indicating that the previous version of the record may no longer be active.

At process 435, the system retains the original “Logical_ID” of the record, which remains consistent for internal tracking, while assigning a new UUID to the updated record. The UUID uniquely identifies the updated version, providing a distinct reference for future access and version control. At process 440, the “Expiration_Date” of the updated record may be set to “Null” indicating that it is the current, active version of the record. Finally, at process 445, the server confirms the successful update of the record and returns a response to the requesting entity, indicating that the operation was completed.

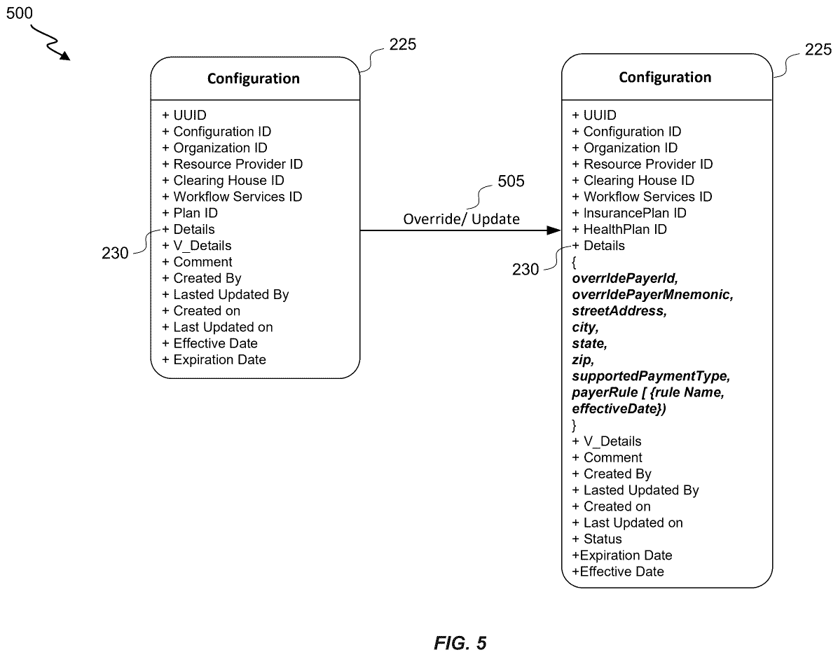

FIG. 5 shows an example illustration of the configuration entity 225 evolving as a result of the override operation in accordance with some aspects of the present disclosure. The configuration entity 225 resides in the centralized database 110 and is specifically responsible for establishing relationship between entities (organization and contributor) and for tracking metadata associated with any overrides or modifications performed on data records within the system. Each time a data record may be updated or modified; a details field 230 within the configuration entity may be created or updated to log details regarding the modification.

In its initial state, the details field 230 in the configuration entity 225 may be empty for a specific record indicating that no override has been performed on the record. However, after an override 505 or modification, the configuration entity 225 may evolve to incorporate details that collectively define the metadata and versioning details of an overridden or modified record or the updated details of the record. The details field 230 may captures critical changes, such as updated contributor identifiers, rules defined by the contributor, effective dates, and modified attributes. The version field (V_Details) may store version-specific contextual information or the version number of the record. The comment field may allow for optional notes regarding the update. The “Created_By” and “Last_Updated_By” fields may document the entities that initiated and modified the record, while “Created_On” and “Last_Updated_On” timestamps provide chronological context. Moreover, the “Effective_Date” may determine when the configuration becomes active, whereas the “Expiration_Date” marks when it is no longer applicable. These attributes collectively enable structured tracking of modifications, facilitating historical analysis and compliance. The details field 230, which initially holds general metadata about the record, may then be expanded to store specific override information such as “Override_Contributor_ID”, identifying the contributor responsible for the update, contributor-related fields such as address, city, state, and zip may be updated to reflect new location details associated with the contributor.

Additionally, a status field may be updated to reflect the current state of the modification, such as “Pending,” “Approved,” or “Expired.” The “Expiration Date” and “Effective Date” may reflect any changes that apply to the updated record, providing a clear timeline for the validity of the override or modification. Similarly, each time a record is updated, a new configuration entity with an updated version number may be created for retaining the base version while tracking the history of modifications. For example, if an insurance company updates a subject's insurance coverage, a new configuration entity 225 may be generated with the updated coverage details, including contributor information, payment type, and the relevant insurance plan. The details field 230 and the version field may be changed to reflect the new values, while other fields like UUID and “Organization ID” may remain the same.

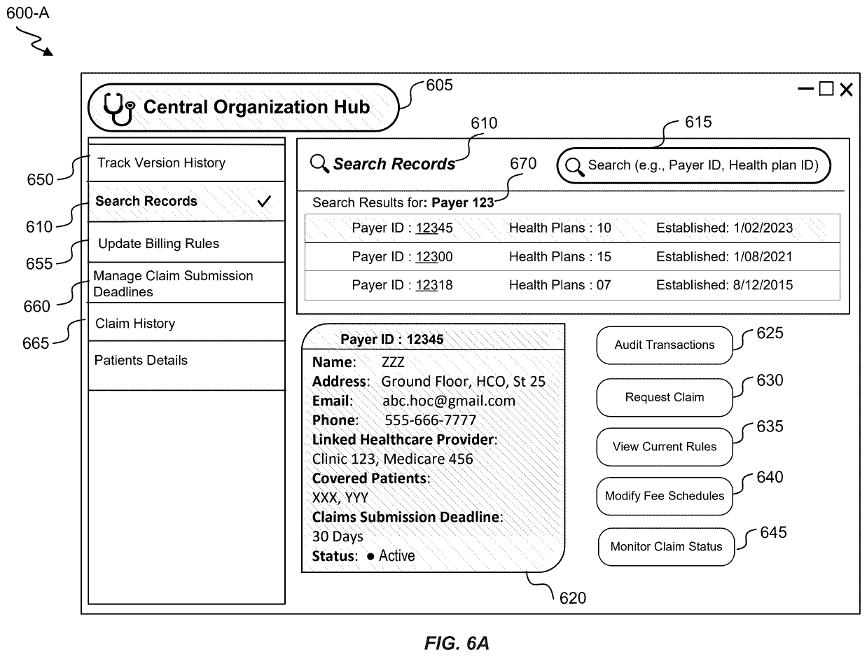

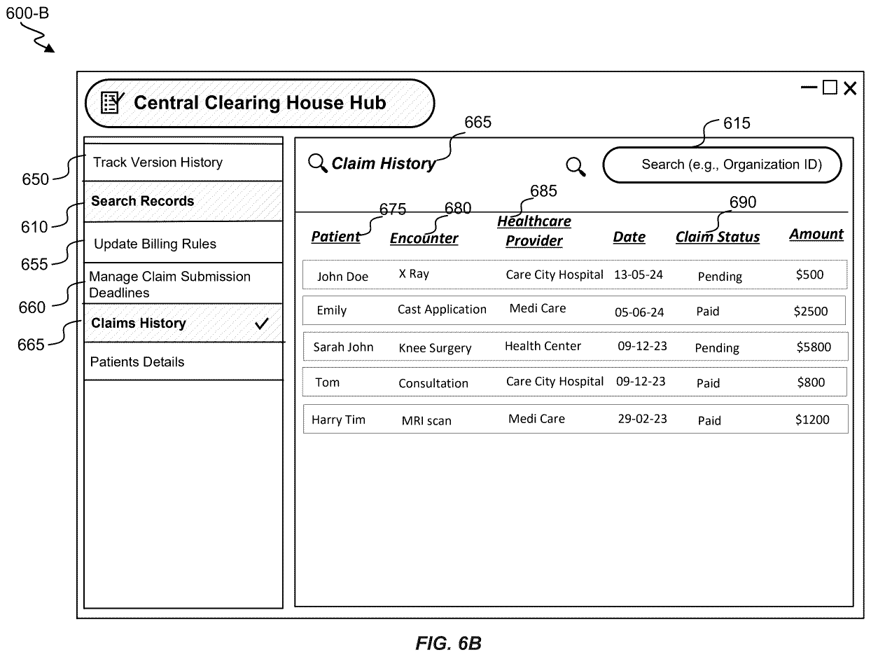

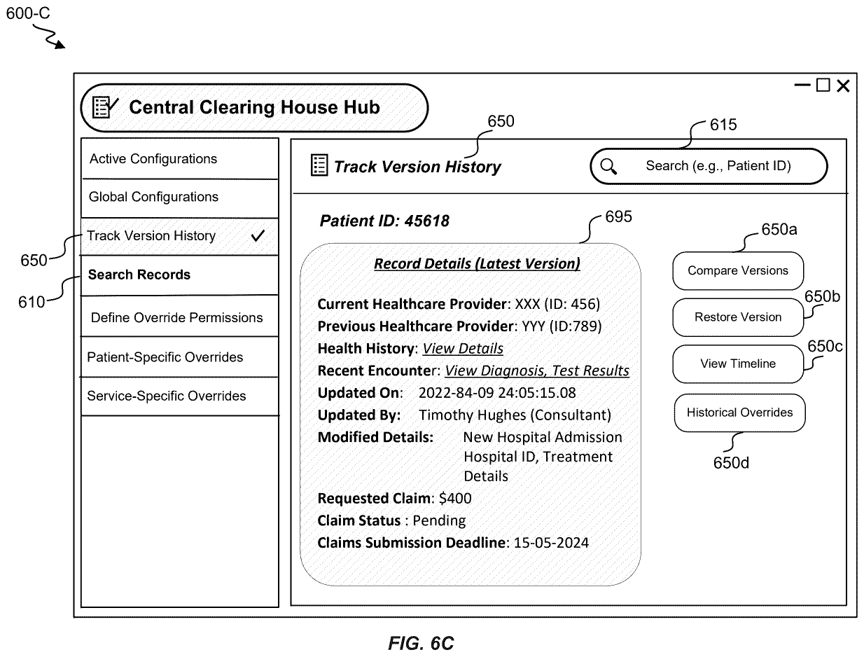

FIG. 6A illustrates an exemplary user interface (UI) showing a dashboard of the centralized database management system at the organization endpoint 135. The database management dashboard provides the authorized users of the hospitals and healthcare providers with a user-friendly interface to efficiently manage contributor interactions, track claim processes, and access historical records. The dashboard may display a central organization hub 605, offering a sidebar with multiple navigation options tailored for hospital needs. These options may include track version history 650, search records 610, update billing rules 655, manage claim submission deadlines 660, claims history 665, view active configurations, set up workflows, and examine override details related to specific subjects. The claim history 665 option may allow healthcare providers to access a comprehensive record of previously submitted claims, including their statuses, modifications, and responses from contributors. Upon selecting this option, the users may view a detailed log of claims, filtered by subject ID, claim ID, contributor ID, submission date, or status (approved, pending, rejected, or modified). This feature may enhance transparency by allowing hospitals to track how claims were processed over time, whether any updates were made by the contributor, and if resubmissions were required.

For example, if a hospital submits a claim for a subject to a contributor, claim history section may show timestamps of when the claim was submitted, reviewed, approved, or denied, along with any modifications applied by the contributor. If a claim was rejected due to incorrect billing codes, the hospital may use this section to view the rejection reason, correct the issue, and resubmit the claim. Additionally, if a contributor updates coverage terms or reimbursement rates, hospitals may see how past claims were adjusted based on new policies.

The healthcare management tab 605 may display a detailed view of the search records 610 tab when the user selects the search records 610 option from the sidebar. This feature may allow hospital users to look up insurance plan details or contributor information using a search bar 615. Users may enter a contributor's name, health plan ID, or contributor ID, and the system may retrieve relevant results displayed in a search results section 670. These results may include a list of contributors along with their contributor IDs and number of health plans associated with each contributor. The hospital may then select a specific contributor or health plan for further details. Upon selecting a contributor, a contributor details section 620 presents comprehensive information, including the contributor's contact details, a list of healthcare providers associated with the contributor, claim submission deadlines, and the current status of the contributor (active or inactive).

Additionally, a list of subjects covered by the selected contributor who are currently receiving treatment at the hospital may also be displayed titled “Covered Patients” or “Eligible Patients”, allowing hospitals to efficiently track which subjects are associated with specific contributors. Beyond contributor details, hospitals may access several options for managing claims associated with the selected contributor. These options may include audit transactions 625 (to view historical changes in contributor or subject data, including modifications to insurance plans or eligibility details), request claims 630 (receive claims directly from the interface and request updates regarding their processing), and view current rules 635 (to access up-to-date contributor-specific billing and claim submission guidelines). Additionally, a monitor claim status 645 option may be used to track submitted claims in real time, identifying approvals, rejections, or pending statuses.

FIG. 6B illustrates an exemplary user interface of a contributor, showing history of requests received from the organization 130. The interface enables insurance representatives to track the status of claims, review financial requests, and manage interactions with hospitals efficiently. Each row in the claim history tab 665 represents an individual claim request received from a healthcare provider, detailing key attributes such as the subject identifier 675, encounter details 680 (treatment or diagnostic test), healthcare provider identifier 685, date of request submission, claim status 690, and the requested claim amount. Such a structured view enhances visibility into the claims process and allows the contributor 115 to take necessary actions promptly.

For instance, if a hospital (e.g., Care City Hospital) submits a claim for “subject ID=P-10234” who underwent an MRI scan, the claim history tab 665 may reflect an entry with the encounter type as MRI, the hospital's identifier, the submission date (e.g., Feb. 5, 2025), the status (Pending or Paid), and the requested claim amount (e.g., $1,200). The contributor may then review the claim details, cross-check supporting documents, and decide whether to approve or request additional information. Similarly, another row may indicate a pending claim from another hospital (e.g., Health Center) for “subject ID=P-20567”, who underwent a knee surgery, with a requested amount of $5,800, awaiting insurance review.

Furthermore, the claim history 665 tab also enables filtering and sorting of records based on status (paid, pending, or under review), date range, healthcare provider, or specific subject identifiers. Beyond just tracking individual claims, the UI may enable the contributors to monitor claim trends, detect anomalies, and streamline payment processes. For example, if multiple claims from a specific hospital show a high rate of denials that may indicate discrepancies in billing practices or missing documentation. Similarly, a high volume of pending claims for a particular healthcare provider may signal the need for additional coordination between the hospital and the insurance company. By centralizing all claims-related interactions in a structured format, the Contributor Management UI facilitates efficient decision-making, ensuring smooth claim approvals and reducing administrative delays.

FIG. 6C shows an exemplary UI of the first server 105 showing version history of a record according to some aspects of the present disclosure. Upon selecting the track version history 650 option from the sidebar, an authorized user of the clearinghouse may efficiently retrieve records by searching through the search bar 615 using a subject's name, unique ID, or the healthcare provider's ID. The UI displays the version history corresponding to subject ID 45618, where each version captures the modifications made over time. The version history tab 650 displays the latest version 695 of the record, including details such as the current healthcare provider's name and ID, the previous healthcare provider (in cases where the subject switched hospitals), and an overview of the subject's health history. A “View Details” option is available for an in-depth look at past medical conditions, prescribed treatments, and test results. Additionally, the recent encounter details showcase the most recent consultation, diagnoses, and procedures performed. The system also logs “Updated On” and “Updated By” details, allowing the users to track who modified the record and when. Notably, any updated fields, such as new hospital admission details, treatment plans, or prescribed medications, may be distinctly highlighted. If the hospital has submitted a claim request for reimbursement based on the latest consultation, the system displays the requested claim amount, its current status (pending or approved), and the submission deadline.

To provide greater flexibility in managing and reviewing record changes, the side panel includes several version tracking functionalities. A compare versions 650a option may enable the user to select two versions and visually compare the differences. This feature may particularly be useful for identifying changes in treatment plans, medications, and provider transitions. For example, if the subject were initially treated for mild hypertension at one hospital but later admitted to another hospital due to additional complications, the system may highlight these updates, including new diagnoses and modified prescriptions. Users may also view insurance-related updates, such as modifications to contributor details or claim amounts.

In cases where an incorrect update has been made or the previous record needs to be reinstated, a restore version 650b option allows the clearinghouse to revert to a prior version while maintaining a complete history of the changes. This functionality helps resolve disputes related to claim discrepancies, misdiagnosed conditions, or errors in billing and treatment records. Meanwhile, a view timeline 650c option may provide a chronological breakdown of all modifications, including who made each change, the reason for the update, and the affected fields. The timeline view may be highly beneficial when analyzing the progression of a subject's medical history and ensuring consistent record-keeping across different healthcare providers.

Lastly, a historical overrides 650d option may capture policy-based or administrative modifications that may have been applied to the record. These overrides may include adjustments to claim policies, updates to insurance plan details, or corrections made due to regulatory compliance requirements. For instance, if a claim were initially flagged as ineligible but later approved due to an updated insurance policy, this section may document the changes made, who authorized them, and their impact on the record. The version tracking options may resultantly support data integrity, improving transparency in subject records, and facilitating smoother communication between hospitals, clearinghouses, and insurance providers.

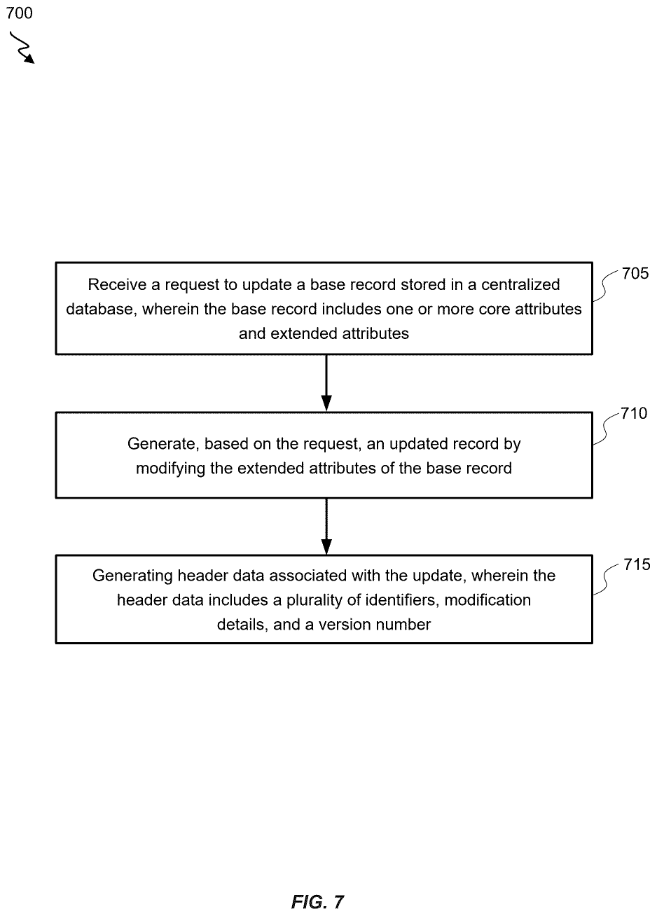

FIG. 7 shows an example flowchart of a system for updating and storing versioning history of records in the centralized database according to some aspects of the present disclosure. The system may receive a request from an entity via an API to modify a base record stored in the centralized database, at block 705. The entity may include a second server, a provider, or an organization that interacts with the database to update subject records, claim details, or other core and extended attributes. The base record may comprise core attributes, such as relational tables, key-value pairs, and indexed records, as well as extended attributes, which includes entity-specific attributes, publicly accessible fields, and metadata for external visibility.

At block 710, the system may process the modification request and generate an updated record by modifying the base record, creating a new version of the base record (an updated record) in the centralized database. To enable proper version tracking, the base record may be labeled as expired, a new UUID assigned to the updated record, and the logical identifier of the base record given to the updated record. This may enable the updated record to maintain its historical lineage while tracking modifications over time. The update may involve modifications such as changes in a subject's healthcare provider, new medical test results, consultation records, or financial claims associated with medical procedures.

At block 715, the system may generate header data associated with the update or override in an configuration entity. The header data may include a plurality of identifiers, such as a UUID for uniquely identifying each record in the centralized database associated with each subject, a logical identifier for internal tracking, a timestamp marking the modification, the entity requesting the modification, and a description of modified fields. By maintaining this configuration entity, the system enables all previous versions to remain accessible for compliance, reporting, and historical review.

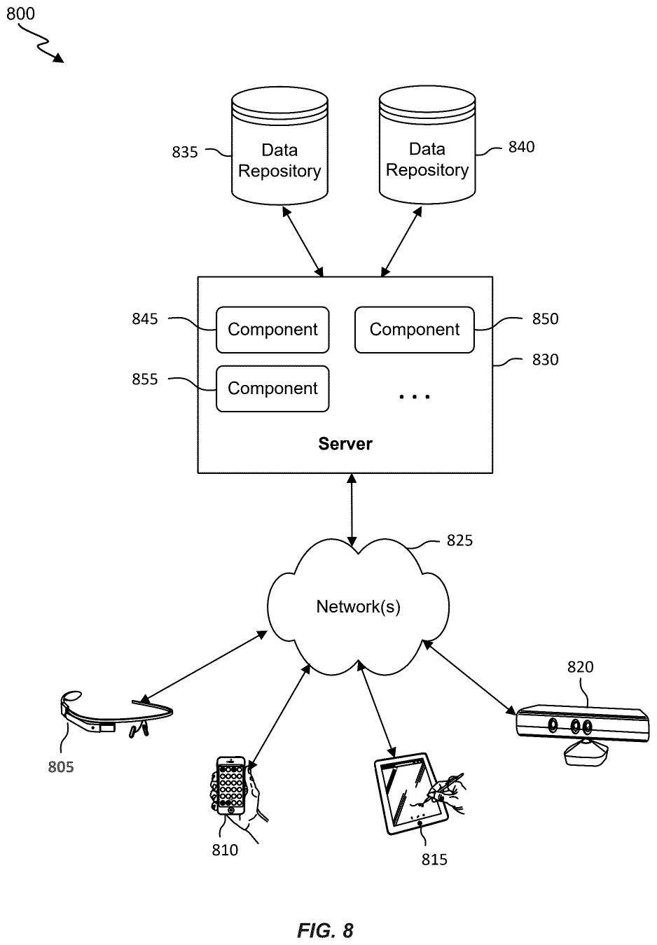

FIG. 8 illustrates a simplified diagram of an example distributed system 800 for a cloud hosting a contributor directory management system. In the illustrated example, the distributed system 800 includes one or more client computing devices 805, 810, 815, and 820, coupled to a server 830 via one or more communication networks 825. The entity computing devices 805, 810, 815, and 820 may be configured to execute one or more applications interact with the server 830 to access and utilize the contributor platform securely integrated within a cloud environment, such as Oracle cloud integrated with Cohere. Within this framework, the server 830 is configured to host and manage a range of services or software applications, facilitating seamless integration and operation of the contributor directory management platform.

In various aspects, the server 830 may extend its capabilities to encompass additional services or software applications. These services may span both virtual and non-virtual environments, enabling a comprehensive and adaptable infrastructure for securely deploying GenAI solutions within the cloud ecosystem. In some respects, these services may be offered as web-based or cloud services, such as under a Software as a Service (SaaS) model to the users of the client computing devices 805, 810, 815, and/or 820. Users operating the client computing devices 805, 810, 815, and/or 820 may in turn utilize one or more client applications to interact with the server 830 to utilize the services provided by these components. Furthermore, client computing devices 805, 810, 815, and/or 820 may in turn utilize one or more client applications to initiate and manage specific tasks or analyses within the contributor directory management system.

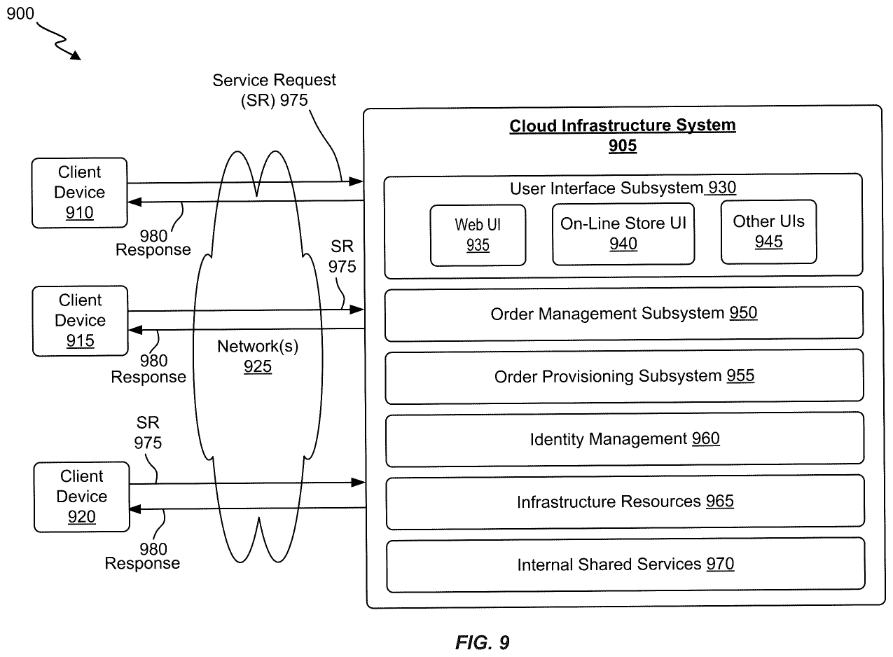

In the configuration depicted in FIG. 8, the server 830 may include one or more components 845, 850 and 855 that implement the functions performed by the server 830. These components may include software components that may be executed by one or more processors, hardware components, or combinations thereof. It should be appreciated that various system configurations are possible, which may differ from distributed system 800. The example shown in FIG. 9 is thus one example of a distributed system for implementing an example system and is not intended to be limiting.

Users may initiate requests for the contributor directory management system through client computing devices 805, 810, 815, and/or 820 for inference or other machine-learning tasks. A client device may provide an interface that enables a user of the client device to interact with the contributor directory management system. The client device may also output information to the user via this interface. Although FIG. 8 depicts only four client computing devices, any number of client computing devices may be supported providing scalability and accessibility within the integrated contributor directory management system on the cloud.

The client devices may include various types of computing systems, such as portable handheld devices, general purpose computers, such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems, such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various applications, such as various Internet-related apps, communication applications (e.g., E-mail applications, short message service (SMS) applications) and may use various communication protocols.

Network(s) 825 may be any type of network familiar to those skilled in the art that may support data communications using any of a variety of available protocols, including without limitation TCP/IP (transmission control protocol/internet protocol), SNA (systems network architecture), IPX (internet packet exchange), AppleTalk®, and the like. Merely by way of example, network(s) 825 may be a local area network (LAN), networks based on ethernet, token-ring, a wide-area network (WAN), the internet, a virtual network, a virtual private network (VPN), an intranet, an extranet, a public switched telephone network (PSTN), an infra-red network, a wireless network (e.g., a network operating under any of the institute of electrical and electronics (IEEE) 1002.11 suite of protocols, Bluetooth®, and/or any other wireless protocol), and/or any combination of these and/or other networks.

The server 830 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The server 830 may include one or more virtual machines running virtual operating systems, or other computing architectures involving virtualization, such as one or more flexible pools of logical storage devices that may be virtualized to maintain virtual storage devices for the server. In various aspects, the server 830 may be adapted to run one or more services or software applications that provide the functionality described in the foregoing disclosure.

The computing systems in the server 830 may run one or more operating systems including any of those discussed above, as well as any commercially available server operating system. The server 830 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

Distributed system 800 may also include one or more data repositories 835, 840. Data repositories 835, 840 may reside in many locations. For example, a data repository used by the server 830 may be local to server 830 or may be remote from the server 830 and in communication with the server 830 via a network-based or dedicated connection. Data repositories 835, 840 may be of different types. In some instances, a data repository used by the server 830 may be a database, for example, a relational database, such as databases provided by Oracle Corporation® and other vendors. One or more of these databases may be adapted to enable storage, update, and retrieval of data to and from the database in response to structured query language (SQL)-formatted commands. In some aspects, one or more data repositories 835, 840 may also be used by applications to store application data. The data repositories used by applications may be of different types, such as, for example, a key-value store repository, an object store repository, or a general storage repository supported by a file system.

FIG. 9 is a simplified block diagram of a cloud-based system environment in which various services of the server 830 of FIG. 8 may be offered as cloud services, in accordance with certain aspects. In the illustrative example depicted in FIG. 9, cloud infrastructure system 905 may provide one or more cloud services that may be requested by users using one or more client devices 910, 915, and 920. Cloud infrastructure system 905 may comprise one or more computers and/or servers that may include those described for server 830. The computers in cloud infrastructure system 905 may be organized as general-purpose computers, specialized server computers, server farms, server clusters, or any other appropriate arrangement and/or combination.

Network(s) 925 may facilitate communication and exchange of data between client devices 910, 915, and 920 and cloud infrastructure system 905. Network(s) 925 may include one or more networks. The networks may be of the same or different types. Network(s) 925 may support one or more communication protocols, including wired and/or wireless protocols, for facilitating the communications.

The illustrative example depicted in FIG. 9 is only one example of a cloud infrastructure system 905 and is not intended to be limiting. It should be appreciated that, in some other aspects, cloud infrastructure system 905 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network, such as the internet by systems (e.g., cloud infrastructure system 905) of a service provider. Typically, in a public cloud environment, servers and systems that make up the cloud service provider's system are different from the client's own on-premises servers and systems. The cloud service provider's systems are managed by the cloud service provider. Clients may thus avail themselves of cloud services provided by a cloud service provider without having to purchase separate licenses, support, or hardware and software resources for the services. For example, a cloud service provider's system may host an application, and a user may, via a network 925 (e.g., the internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 905 may provide one or more cloud services using different models, such as under a Software as a Service (SaaS) model, a Platform as a Service (PaaS) model, an Infrastructure as a Service (IaaS) model, and others, including hybrid service models. Cloud infrastructure system 905 may include a suite of applications, middleware, databases, and other resources that enable provision of the various cloud services.

A SaaS model enables an application or software to be delivered to a client over a communication network like the Internet, as a service, without the client having to buy the hardware or software for the underlying application. For example, a SaaS model may be used to provide clients access to on-demand applications that are hosted by cloud infrastructure system 905. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a client as a cloud service to provide elastic compute and storage capabilities. Various IaaS services are provided by Oracle Corporation®.

A PaaS model is generally used to provide, as a service, platform and environment resources that enable clients to develop, run, and manage applications and services without the client having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, universally available, and secure manner. For example, a client, via a subscription order, may order one or more services provided by cloud infrastructure system 905. Cloud infrastructure system 905 then performs processing to provide the services requested in the client's subscription order. Cloud infrastructure system 905 may be configured to provide one or even multiple cloud services.

Cloud infrastructure system 905 may provide cloud services via different deployment models. In a public cloud model, cloud infrastructure system 905 may be owned by a third-party cloud services provider and the cloud services are offered to any general public client, where the client may be an individual or an enterprise. In certain other aspects, under a private cloud model, cloud infrastructure system 905 may be operated within an organization (e.g., within an enterprise organization) and services provided to clients that are within the organization. For example, the clients may be various departments of an enterprise, such as the Human Resources department, the payroll department, etc. or even individuals within the enterprise. In certain other aspects, under a community cloud model, the cloud infrastructure system 905 and the services provided may be shared by several organizations in a related community. Various other models, such as hybrids of the above-mentioned models may also be used.

Client devices 910, 915, and 920 may be of several types (such as client computing devices 805, 810, 815, and 820 depicted in FIG. 8) and may be capable of operating one or more client applications. A user may use a client device to interact with cloud infrastructure system 905, such as to request a service provided by cloud infrastructure system 905. For instance, a user might employ a client device to execute real-time data querying operations within the cloud. A client may use a client device, such as a laptop to interact with the Subject management system integrated within cloud infrastructure system. The client may request GPU-accelerated computing instances of the cloud for training deep learning models. The cloud may provide the necessary resources, and the subject client may monitor and manage the training process through the laptop. Upon completion, the client may retrieve the trained models and results.

In certain aspects, to facilitate efficient provisioning of these resources for supporting the various cloud services provided by cloud infrastructure system 905 for different clients, the resources may be bundled into sets of resources or resource modules. Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 905 may comprise multiple subsystems. These subsystems may be implemented in software, or hardware, or combinations thereof. As depicted in FIG. 9, the subsystems may include a user interface subsystem 930 that enables users or clients of cloud infrastructure system 905 to interact with cloud infrastructure system 905. User interface subsystem 930 may include various interfaces, such as a web user interface 935, an online store interface 940 where cloud services provided by cloud infrastructure system 905 are advertised and are purchasable by a consumer, and other interfaces 945. For example, a client may, using a client device, request (service request 975) one or more services provided by cloud infrastructure system 905 using one or more of interfaces 935, 940, and 945. For example, a client may access the online store, browse cloud services offered by cloud infrastructure system 905, and place a subscription order for one or more services offered by cloud infrastructure system 905 that the client wishes to subscribe to. The service request may include information identifying the client and one or more services that the client desires to subscribe to. For example, a client may place a subscription order for a Chabot related service offered by cloud infrastructure system 905. As part of the order, the client may provide information identifying for input (e.g., utterances).

In certain aspects, such as the illustrative example depicted in FIG. 9, cloud infrastructure system 905 may comprise an order management subsystem (OMS) 950 that is configured to process the new order. As part of this processing, OMS 950 may be configured to: create an account for the client, if not done already; receive billing and/or accounting information from the client that is to be used for billing the client for providing the requested service to the client; verify the client information; upon verification, book the order for the client; and orchestrate various workflows to prepare the order for provisioning.

Once properly validated, OMS 950 may then invoke the order provisioning subsystem (OPS) 955 that is configured to provision resources for the order including processing, memory, and networking resources. The provisioning may include allocating resources for the order and configuring the resources to facilitate the service requested by the client order. The way resources are provisioned for an order and the type of the provisioned resources may depend upon the type of cloud service that has been ordered by the client. For example, according to one workflow, OPS 955 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the requesting client for providing the requested service.

Cloud infrastructure system 905 may itself internally use services 970 that are shared by different components of cloud infrastructure system 905 and which facilitate the provisioning of services by cloud infrastructure system 905. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like. As depicted in the illustrative example in FIG. 9, cloud infrastructure system 905 may include infrastructure resources 965 that may be utilized for facilitating the provision of various cloud services offered by cloud infrastructure system 905. Infrastructure resources 965 may include, for example, processing resources, storage or memory resources, networking resources, and the like. Cloud infrastructure system 905 may send a response or notification 980 to the requesting client to indicate when the requested service is now ready for use. In some instances, information (e.g., a link) may be sent to the client that enables the client to start using and availing the benefits of the requested services.

Cloud infrastructure system 905 may provide services to multiple clients in parallel. Cloud infrastructure system 905 may store information for these clients, including possibly proprietary information. In certain aspects, cloud infrastructure system 905 comprises an identity management subsystem (IMS) 960 that is configured to manage client's information and provide the separation of the managed information such that information related to one client is not accessible by another client. IMS 960 may be configured to provide various security-related services, such as identity services, such as information access management, authentication and authorization services, services for managing client identities and roles and related capabilities, and the like.

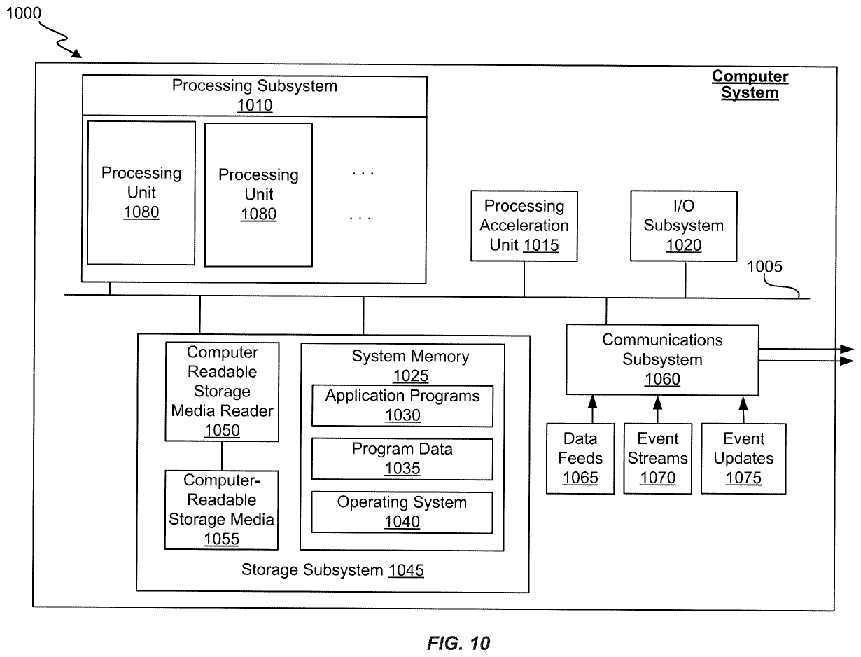

FIG. 10 illustrates an exemplary computer system 1000 that may be used to implement certain aspects of the present disclosure. For example, a computer system 1000 may facilitate the integration of a Subject management system with the cloud by provisioning and configuring resources, managing data, implementing security measures, monitoring performance, and enabling scalability. It may serve as the foundational infrastructure, enabling seamless deployment and operation of AI applications within the cloud environment while providing flexibility and scalability to adapt to changing computational demands efficiently. In some aspects, computer system 1000 may be used to implement various servers as described above. As shown in FIG. 10, computer system 1000 may include various subsystems including a processing subsystem 1010 that communicates with a few other subsystems via a bus subsystem 1005. These other subsystems may include a processing acceleration unit 1015, and I/O subsystem 1020, a storage subsystem 1045, and a communications subsystem 1060. Storage subsystem 1045 may include non-transitory computer-readable storage media including storage media 1055 and a system memory 1025.

Bus subsystem 1005 provides a mechanism for letting the various components and subsystems of computer system 1000 communicate with each other as intended. Although bus subsystem 1005 is shown schematically as a single bus, alternative aspects of the bus subsystem may utilize multiple buses. Bus subsystem 1005 may be any of several types of bus structures including a memory bus or memory controller, a peripheral bus, a local bus using any of a variety of bus architectures, and the like. For example, such architectures may include an industry standard architecture (ISA) bus, micro channel architecture (MCA) bus, enhanced ISA (EISA) bus, video electronics standards association (VESA) local bus, and peripheral component interconnect (PCI) bus, which may be implemented as a Mezzanine bus manufactured to the IEEE P1386.1 standard, and the like.

Processing subsystem 1010 controls the operation of computer system 1000 and may comprise one or more processors, application specific integrated circuits (ASICs), or field programmable gate arrays (FPGAs). The processors may include single core or multicore processors. The processing resources of computer system 1000 may be organized into one or more processing units 1080, 1080, etc. A processing unit may include one or more processors, one or more cores from the same or different processors, a combination of cores and processors, or other combinations of cores and processors. In some aspects, processing subsystem 1010 may include one or more special purpose co-processors, such as graphics processors, digital signal processors (DSPs), or the like. In some aspects, some or all of the processing units of processing subsystem 1010 may be implemented using customized circuits, such as application specific integrated circuits (ASICs), or field programmable gate arrays (FPGAs).

In some aspects, the processing units in processing subsystem 1010 may execute instructions stored in system memory 1025 or on computer readable storage media 1055. In various aspects, the processing units may execute a variety of programs or code instructions and may maintain multiple concurrently executing programs or processes. At any given time, some, or all of the program code to be executed may be resident in system memory 1025 and/or on computer-readable storage media 1055 including potentially on one or more storage devices. Through suitable programming, processing subsystem 1010 may provide various functionalities described above. In instances where computer system 1000 is executing one or more virtual machines, one or more processing units may be allocated to each virtual machine.

In certain aspects, a processing acceleration unit 1015 may optionally be provided for performing customized processing or for off-loading some of the processing performed by processing subsystem 1010 to accelerate the overall processing performed by computer system 1000.

I/O subsystem 1020 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices, such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices, such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices, such as computed tomography, magnetic resonance imaging, position emission tomography, and medical ultrasonography devices. User interface input devices may also include, for example, audio input devices, such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays, such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics, and audio/video information, such as monitors, printers, speakers, headphones, automotive navigation systems, plotters, voice output devices, and modems.

Storage subsystem 1045 provides a repository or data store for storing information and data that is used by computer system 1000. Storage subsystem 1045 provides a tangible non-transitory computer-readable storage medium for storing the basic programming and data constructs that provide the functionality of some aspects. Storage subsystem 1045 may store software (e.g., programs, code modules, instructions) that when executed by processing subsystem 1010 provides the functionality described above. The software may be executed by one or more processing units of processing subsystem 1010. Storage subsystem 1045 may also provide a repository for storing data used in accordance with the teachings of this disclosure.

Storage subsystem 1045 may include one or more non-transitory memory devices, including volatile and non-volatile memory devices. As shown in FIG. 10, storage subsystem 1045 includes a system memory 1025 and a computer-readable storage media 1055. System memory 1025 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1010. In some implementations, system memory 1025 may include multiple different types of memory, such as static random-access memory (SRAM), dynamic random-access memory (DRAM), and the like.

By way of example, and not limitation, as depicted in FIG. 10, system memory 1025 may load application programs 1030 that are being executed, which may include various applications, such as Web browsers, mid-tier applications, relational database management systems (RDBMS), etc., program data 1035, and an operating system 1040. By way of example, operating system 1040 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, Palm® OS operating systems, and others.

Computer-readable storage media 1055 may store programming and data constructs that provide the functionality of some aspects. Computer-readable media 1055 may provide storage of computer-readable instructions, data structures, program modules, and other data for computer system 1000. Software (programs, code modules, instructions) that, when executed by processing subsystem 1010 provides the functionality described above, may be stored in storage subsystem 1045. By way of example, computer-readable storage media 1055 may include non-volatile memory, such as a hard disk drive, a magnetic disk drive, an optical disk drive, such as a CD ROM, digital video disc (DVD), a Blu-Ray® disk, or other optical media. Computer-readable storage media 1055 may include, but is not limited to, Zip® drives, flash memory cards, universal serial bus (USB) flash drives, secure digital (SD) cards, DVD disks, digital video tape, and the like. Computer-readable storage media 1055 may also include, solid-state drives (SSD) based on non-volatile memory, such as flash-memory based SSDs, enterprise flash drives, solid state ROM, and the like, SSDs based on volatile memory, such as solid-state RAM, dynamic RAM, static RAM, dynamic random access memory (DRAM)-based SSDs, magneto resistive RAM (MRAM) SSDs, and hybrid SSDs that use a combination of DRAM and flash memory based SSDs.

In certain aspects, storage subsystem 1045 may also include a computer-readable storage media reader 1050 that may further be connected to computer-readable storage media 1055. The computer-readable storage media reader 1050 may receive and be configured to read data from a memory device, such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program, such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1060 provides an interface to other computer systems and networks. Communications subsystem 1060 serves as an interface for receiving data from and transmitting data to other systems from computer system 1000. For example, communications subsystem 1060 may enable computer system 1000 to establish a communication channel to one or more client devices via the Internet for receiving and sending information from and to the client devices. For example, the communication subsystem may be used to transmit a response to a user regarding the inquiry for a Chatbot.

Communication subsystem 1060 may support both wired and/or wireless communication protocols. For example, in certain aspects, communications subsystem 1060 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects, communications subsystem 1060 may provide wired network connectivity (e.g., Ethernet) in addition to or instead of a wireless interface.

Communication subsystem 1060 may receive and transmit data in various forms. For example, in some aspects, in addition to other forms, communications subsystem 1060 may receive input communications in the form of data feeds 1065 such as structured and/or unstructured data feeds, event streams 1070, event updates 1075, and the like. For example, communications subsystem 1060 may be configured to receive (or send) data feeds 1065 in real-time from users of social media networks and/or other communication services, such as Twitter® feeds, Facebook® updates, web feeds, such as Rich Site Summary (RSS) feeds, and/or real-time updates from one or more third party information sources.

In certain aspects, communications subsystem 1060 may be configured to receive data in the form of continuous data streams, which may include event streams 1070 of real-time events and/or event updates 1075, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1060 may also be configured to communicate data from computer system 1000 to other computer systems or networks. The data may be communicated in various forms, such as structured and/or unstructured data feeds 1065, event streams 1070, event updates 1075, and the like to one or more databases that may be in communication with one or more streaming data source computers coupled to computer system 1000.

Computer system 1000 may be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in art may appreciate other ways and/or methods to implement the various aspects.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed:

1. A computer-implemented method comprising:
receiving, from a user interface, a request to update a base record stored in a centralized database, wherein the base record includes one or more core attributes and one or more extended attributes;
generating, based on the request, an updated record by modifying the one or more extended attributes of the base record; and
generating header data associated with the updated record in a configuration entity, wherein the header data includes:
a plurality of identifiers that include a universally unique identifier (UUID) and a logical identifier that defines an internal association between the base record and the updated record;
modification details that include a timestamp of modification, an entity name requesting the modification and a description of modified fields; and
a version number of the updated record that defines a sequential iteration of the updated record.

2. The computer-implemented method of claim 1, further comprising:
receiving, from the user interface, a subsequent request to access a record from the centralized database;
parsing, via one or more semantic parsing techniques, the subsequent request into the plurality of identifiers associated with the record;
determining, based on the plurality of identifiers, an entry corresponding to the record in the configuration entity;
identifying, based on the determination, a plurality of versions of the record from the entry;
extracting, based on one or more entity-specific access rules and an entity preference, a version of the record of the plurality of versions of the record, wherein the version of the record is the base record or the updated record; and
outputting, in response to the subsequent request, the version of the record to the user interface.

3. The computer-implemented method of claim 2, wherein parsing the subsequent request into the plurality of identifiers associated with the record further includes:
identifying a request type associated with the subsequent request, wherein the request type defines whether the subsequent request is a PUT request to update the record or a GET request to retrieve the record; and
extracting a universally unique identifier (UUID) and a logical identifier from the subsequent request.

4. The computer-implemented method of claim 2, wherein the one or more semantic parsing techniques include regular expression-based tokenization or named entity recognition (NER) model.

5. The computer-implemented method of claim 2, wherein the entry corresponding to the record in the configuration entity is determined by using a siamese neural network or a fuzzy matching algorithm based on a logical identifier.

6. The computer-implemented method of claim 1, wherein generating the header data associated with the updated record in the configuration entity further includes:
labeling the base record as expired;
assigning new UUID to the updated record; and
assigning the logical identifier of the base record to the updated record for version tracking.

7. The computer-implemented method of claim 1, wherein the centralized database comprises versions of the base record accessible to one or more entities.

8. A system comprising:
one or more processors; and
one or more non-transitory computer-readable media storing instructions, which, when executed by the system, cause the system to perform a set of actions including:
receiving, from a user interface, a request to update a base record stored in a centralized database, wherein the base record includes one or more core attributes and one or more extended attributes;
generating, based on the request, an updated record by modifying the one or more extended attributes of the base record; and
generating header data associated with the updated record in a configuration entity, wherein the header data includes:
a plurality of identifiers that include a universally unique identifier (UUID) and a logical identifier that defines an internal association between the base record and the updated record;
modification details that include a timestamp of modification, an entity name requesting the modification and a description of modified fields; and
a version number of the updated record that defines a sequential iteration of the updated record.

9. The system of claim 8, wherein the set of actions further includes:
receiving, from the user interface, a subsequent request to access a record from the centralized database;
parsing, via one or more semantic parsing techniques, the subsequent request into the plurality of identifiers associated with the record;
determining, based on the plurality of identifiers, an entry corresponding to the record in the configuration entity;
identifying, based on the determination, a plurality of versions of the record from the entry;
extracting, based on one or more entity-specific access rules and an entity preference, a version of the record of the plurality of versions of the record, wherein the version of the record is the base record or the updated record; and
outputting, in response to the subsequent request, the version of the record to the user interface.

10. The system of claim 9, wherein parsing the subsequent request into the plurality of identifiers associated with the record further includes:
identifying a request type associated with the subsequent request, wherein the request type defines whether the subsequent request is a PUT request to update the record or a GET request to retrieve the record; and
extracting a universally unique identifier (UUID) and a logical identifier from the subsequent request.

11. The system of claim 9, wherein the one or more semantic parsing techniques include regular expression-based tokenization or named entity recognition (NER) model.

12. The system of claim 9, wherein the entry corresponding to the record in the configuration entity is determined by using a siamese neural network or a fuzzy matching algorithm based on a logical identifier.

13. The system of claim 8, wherein generating the header data associated with the updated record in the configuration entity further includes:
labeling the base record as expired;
assigning new UUID to the updated record; and
assigning the logical identifier of the base record to the updated record for version tracking.

14. The system of claim 8, wherein the centralized database comprises versions of the base record accessible to one or more entities.

15. A computer-program product tangibly embodied in a non-transitory machine-readable storage medium, including instructions configured to cause one or more data processors to perform a set of actions including:
receiving, from a user interface, a request to update a base record stored in a centralized database, wherein the base record includes one or more core attributes and one or more extended attributes;
generating, based on the request, an updated record by modifying the one or more extended attributes of the base record; and
generating header data associated with the updated record in a configuration entity, wherein the header data includes:
a plurality of identifiers that include a universally unique identifier (UUID) and a logical identifier that defines an internal association between the base record and the updated record;
modification details that include a timestamp of modification, an entity name requesting the modification and a description of modified fields; and
a version number of the updated record that defines a sequential iteration of the updated record.

16. The computer-program product of claim 15, wherein the set of actions further includes:
receiving, from the user interface, a subsequent request to access a record from the centralized database;
parsing, via one or more semantic parsing techniques, the subsequent request into the plurality of identifiers associated with the record;
determining, based on the plurality of identifiers, an entry corresponding to the record in the configuration entity;
identifying, based on the determination, a plurality of versions of the record from the entry;
extracting, based on one or more entity-specific access rules and an entity preference, a version of the record of the plurality of versions of the record, wherein the version of the record is the base record or the updated record; and
outputting, in response to the subsequent request, the version of the record to the user interface.

17. The computer-implemented method of claim 16, wherein parsing the subsequent request into the plurality of identifiers associated with the record further includes:
identifying a request type associated with the subsequent request, wherein the request type defines whether the subsequent request is a PUT request to update the record or a GET request to retrieve the record; and
extracting a universally unique identifier (UUID) and a logical identifier from the subsequent request.

18. The computer-implemented method of claim 16, wherein the one or more semantic parsing techniques include regular expression-based tokenization or named entity recognition (NER) model.

19. The computer-implemented method of claim 16, wherein the entry corresponding to the record in the configuration entity is determined by using a siamese neural network or a fuzzy matching algorithm based on a logical identifier.

20. The computer-implemented method of claim 15, wherein generating the header data associated with the updated record in the configuration entity further includes:
labeling the base record as expired;
assigning new UUID to the updated record; and
assigning the logical identifier of the base record to the updated record for version tracking.
